(19) United States
(12) Patent Application Publication
(10) Pub. No.: US 2024/0344223 A1
(43) Pub. Date: Oct. 17, 2024

(54) Growth of Nanowires

(71) Applicant: NanoWired GmbH, Gernsheim (DE)

(72) Inventors: Olav Birlem, Gernsheim (DE); Florian Dassinger, Gernsheim (DE); Sebastian Quednau, Gernsheim (DE); Farough Roustaie, Gernsheim (DE)

(21) Appl. No.: 18/685,365

(22) PCT Filed: Sep. 28, 2022
(86) PCT No.: PCT/EP2022/077019

§ 371 Date: Feb. 21, 2024

(30) Foreign Application Priority Data
Oct. 12, 2021 (DE) 10 2021 126 435.9

(51) Int. Cl. C25D 1/04; B82Y 40/00; C25D 1/00

(52) U.S. Cl. CPC C25D 1/04; B82Y 40/00; C25D 1/006

(57) ABSTRACT

Arrangement for producing a plurality of nanowires, comprising the following elements, which are arranged in the order indicated:
an electrically conductive surface,
a foil having a plurality of channels, which extend from a first side of the foil to a second side of the foil opposite to the first side,
a first electrolyte-permeable layer,
a second electrolyte-permeable layer, which is more compressible than the first electrolyte-permeable layer,
   wherein the arrangement furthermore has an electrode, and wherein the arrangement is adapted so that the nanowires can be grown onto the electrically conductive surface by electrodeposition from an electrolyte into the channels of the foil by applying an electrical voltage between the electrically conductive surface and the electrode.

The invention relates to the growth of nanowires on a surface.

It is known to grow nanowires onto an electrically conductive surface by electrodeposition from an electrolyte. One example is described in DE 10 2017 104 906 A1. In this case, a foil is applied onto the surface to be grown on. The foil has continuous channels, which are referred to in DE 10 2017 104 906 A1 as pores. The nanowires can be grown into the channels. The foil may subsequently be removed, for example by etching, in order to expose the grown nanowires.

The nanowires may, in particular, be used to connect components to one another. For this purpose, nanowires are grown onto the surface of one or both components. The components are subsequently brought together so that the nanowires of the one component connect to the surface of the other component, or the nanowires of the surfaces of the two components connect to one another.

It is desirable for the nanowires to be grown uniformly on the surface. This requires the electrolyte to be distributed uniformly over the foil. For this purpose, according to DE 10 2017 104 906 A1, a sponge is provided as a means for supplying the electrolyte. The electrolyte can be distributed over the foil through the sponge.

With the sponge, the foil may also be pressed onto the surface. This is intended to prevent material from being deposited at undesired positions between the surface to be grown on and the foil. Without this pressing, material could also accumulate between the surface to be grown on and the foil outside the region in which the nanowires are intended to be grown. This effect will be referred to below as “lateral growth”. Insofar as lateral growth is undesired, it may also be referred to as “parasitic lateral growth”. Lateral growth may be prevented by pressing the foil sufficiently strongly onto the surface to be grown on. In this way, however, pores of the sponge may become clogged and/or channels of the foil may be closed, so that the nanowires would grow nonuniformly.

Even disregarding the problem of lateral growth, it is desirable to press the foil onto the surface to be grown on during the growth of the nanowires. In this way, the nanowires may be grown directly onto the surface. If the foil bears too loosely on the surface to be grown on, too much material will accumulate between the surface to be grown on and the foil. This may lead to the nanowires becoming unstable. Furthermore, a solid thickening region of the deposited material would initially be formed, which may be referred to as a bump. Such a bump could lead to an undesirably large gap being formed between surfaces of components to be connected to one another. Furthermore, such a bump could lead to components being connectable to one another only with a relatively large spacing from one another. Particularly in the case of surface-wide contacts, the geometrical height of the connection or the overall thickness of the components connected to one another may thus be greater than is desired. Especially for geometrically challenging modules such as mobile phones, tablets or televisions, this is particularly critical.

Although good results may already be achieved with the solution according to DE 10 2017 104 906 A1, a compromise must nevertheless in this case be found between uniform growth of the nanowires and pressing of the foil onto the surface to be grown on.

On the basis of the described prior art, it is an object of the present invention to provide a way of growing nanowires particularly uniformly, with particularly low lateral growth and particularly stably.

This object is achieved by a method and an arrangement according to the independent claims. Further advantageous configurations are specified in the dependent claims. The features presented in the claims and the description may be combined with one another in any desired technically feasible way.

According to the invention, an arrangement for producing a plurality of nanowires is provided. The arrangement comprises the following elements, which are arranged in the order indicated:
an electrically conductive surface,
a foil having a plurality of channels, which extend from a first side of the foil to a second side of the foil opposite to the first side,
a first electrolyte-permeable layer,
a second electrolyte-permeable layer, which is more compressible than the first electrolyte-permeable layer,
   wherein the arrangement furthermore has an electrode, and wherein the arrangement is adapted so that the nanowires can be grown onto the electrically conductive surface by electrodeposition from an electrolyte into the channels of the foil by applying an electrical voltage between the electrically conductive surface and the electrode.

With the described arrangement, a plurality of nanowires can be produced on the electrically conductive surface, in particular by means of electrodeposition growth. The electrically conductive surface may be part of an electrically conductive body. If nanowires are intended to be produced on an electrically nonconductive or insufficiently conductive body, the surface of the body or a part thereof may be metallised so that an electrically conductive surface is obtained.

A nanowire is intended here to mean any physical body which has a shape similar to a wire and a size in the nanometre range. A nanowire may for example have a circular, oval or polygonal base face. In particular, a nanowire may have a hexagonal base face. The nanowires are preferably formed from a metal, for example copper. Preferably, all the nanowires are formed from the same material. The nanowires are preferably perpendicular to the surface. In this case, the nanowires are arranged in the manner of a lawn.

Preferably, the nanowires have a length in the range of from 100 nm [nanometres] to 100 μm [micrometres], particularly in the range of from 500 nm to 50 μm. Furthermore, the nanowires preferably have a diameter in the range of from 10 to 10 000 nm, particularly in the range of from 30 to 4000 nm. In this case, the term diameter refers to a circular base face, while a similar definition of a diameter is to be used in the case of a base face differing therefrom. It is particularly preferred for all the nanowires used to have the same length and the same diameter.

The nanowires may, in particular, be used to connect components to one another. For instance, nanowires may be grown onto the contact face of a first component and onto the contact face of a second component. The two contact faces are in this case respectively used as the electrically conductive surface of the described arrangement. Subsequently, the two components may be brought together so that the nanowires of the two contact faces come in contact with one another. Because of the large surface area of the nanowires, this creates a mechanically stable connection which is also electrically conductive in the case of electrically conductive nanowires and/or thermally conductive in the case of thermally conductive nanowires. The connection can be formed without great outlay. In particular, high temperatures such as are involved in conventional connecting technologies of the electronics industry, for example during soldering, are not required. The connection may be reinforced by temporarily pressing the components together with an elevated pressure. As an alternative, the components may also be connected if only the contact face of a first of the components is grown on with nanowires. If the components are then brought together and heated, for example to at least 90° C., the nanowires become connected to the contact face of the second component. An adhesive may additionally be used in both method variants in order to reinforce the connection.

The arrangement furthermore comprises a foil having a plurality of channels, which extend from a first side of the foil to a second side of the foil opposite to the first side. The channels are thus continuous and extend through the foil. The channels are arranged and configured in the same way as the nanowires to be grown. By electrodeposition growth, the channels can be filled with material so that the nanowires can be produced. After the growth of the nanowires, the foil may be removed, for example by etching. The nanowires may thus be exposed and, for example, used for the connection of components.

The arrangement furthermore comprises a first electrolyte-permeable layer and a second electrolyte-permeable layer. The two electrolyte-permeable layers are used together to distribute the electrolyte uniformly over the foil, in order to achieve uniform growth of the nanowires. In addition, the foil may be pressed by means of the two electrolyte-permeable layers onto the electrically conductive surface, in order to restrict lateral growth and prevent too much material from being deposited between the foil and the electrically conductive surface. By the subdivision into a first electrolyte-permeable layer and a more compressible second electrolyte-permeable layer, these advantages may simultaneously be achieved to a particular extent. The first electrolyte-permeable layer is less compressible than the second electrolyte-permeable layer. Thus, if a force is exerted on the second electrolyte-permeable layer in the direction of the electrically conductive surface, the second electrolyte-permeable layer in particular is compressed. By means of the first electrolyte-permeable layer, the foil is in this case pressed onto the electrically conductive surface and/or onto a lithography layer. This prevents too much material from accumulating between the foil and the electrically conductive surface. Lateral growth is thus restricted. If the second electrolyte-permeable layer is compressed, it is possible that the electrolyte will not be delivered uniformly onto the first electrolyte-permeable layer from the second electrolyte-permeable layer. Yet since the first electrolyte-permeable layer is less compressible than the second electrolyte-permeable layer, the first electrolyte-permeable layer is compressed less strongly than the second electrolyte-permeable layer. The pores of the first electrolyte-permeable layer therefore remain more open than the pores of the second electrolyte-permeable layer. The possibly nonuniform delivery of the electrolyte from the second electrolyte-permeable layer onto the first electrolyte-permeable layer may thereby be compensated for, so that the electrolyte can be delivered uniformly from the first electrolyte-permeable layer onto the foil and the nanowires can be grown uniformly in the channels of the foil. The described arrangement has two electrolyte-permeable layers with different properties. The arrangement may also have more than two electrolyte-permeable layers. This allows even more refined functional distribution onto the individual electrolyte-permeable layers. The described advantages may thus be achieved commensurately more.

The foil can be pressed onto the electrically conductive surface by the first electrolyte-permeable layer and the second electrolyte-permeable layer. By the pressing, the electrolyte can be delivered from the second electrolyte-permeable layer onto the first electrolyte-permeable layer and from the first electrolyte-permeable layer onto the foil. If there were only a single electrolyte-permeable layer, this could optionally be so compressible that the electrolyte could be delivered it with by pressing. In this case, the electrolyte-permeable layer as a spring system could compensate for local irregularities on the surface to be grown on and/or on the foil, and ensure that the foil is pressed uniformly onto the surface to be grown on over the entire surface to be grown on. In this way, however, the electrolyte-permeable layer becomes increasingly dense with an increasing application force, so that zones which are then only poorly accessible for the electrolyte are formed inside the electrolyte-permeable layer. In this way, local depletions of the electrolyte may occur during the growth of the nanowires. This may in turn lead to the nanowires growing nonuniformly. Furthermore, the pores of the electrolyte-permeable layer may even become clogged and/or channels of the foil may be closed.

As an alternative, the electrolyte-permeable layer could be compressible so little that the disadvantages described above do not occur. In this case, the microporosity of the electrolyte-permeable layer could also remain constant with an increasing application force. In this way, good mixing of the electrolyte in the electrolyte-permeable layer could be achieved over a large range of the application force. The disadvantage of an incompressible electrolyte-permeable layer is, however, that irregularities of the surface to be grown on and/or of the foil cannot be compensated for sufficiently. There may thus be zones on the surface to be grown on in which the foil is pressed very tightly onto the surface to be grown on and zones in which a gap still remains between the surface and the foil.

With the described arrangement, the disadvantages described above may be overcome. By the combination of two electrolyte-permeable layers, on the one hand a spring effect may be achieved in order to compensate for irregularities. On the other hand, even with a large application force, clogging of the channels of the foil can be prevented and good mixing of the electrolyte can be maintained. This is possible because the electrolyte can initially be distributed roughly with the second electrolyte-permeable layer and can be delivered by pressing the latter onto the first electrolyte-permeable layer. Only fine distribution is then required in the first electrolyte-permeable layer. The first electrolyte-permeable layer may thus be configured in such a way that it can deliver the electrolyte well despite a low compressibility. The pores can more easily remain open in the less compressible first electrolyte-permeable layer.

The first electrolyte-permeable layer preferably has a negligible compressibility. It may therefore also be referred to as incompressible. Here, this should be understood as meaning that the first electrolyte-permeable layer is not compressed significantly with the forces conventionally occurring during operation of the arrangement.

The first electrolyte-permeable layer and the second electrolyte-permeable layer are permeable for the electrolyte. This is not restricted to a particular direction. In particular, the electrolyte may not only penetrate through the first electrolyte-permeable layer and the second electrolyte-permeable layer in a direction perpendicular to the electrically conductive surface but also propagate parallel to the electrically conductive surface inside the first electrolyte-permeable layer or inside the second electrolyte-permeable layer. Thus, the electrolyte may be distributed parallel to the electrically conductive surface by means of the first electrolyte-permeable layer and the second electrolyte-permeable layer. This allows particularly uniform growth of the nanowires. That the first electrolyte-permeable layer and the second electrolyte-permeable layer are preferably porous may also be described as the first electrolyte-permeable layer and the second electrolyte-permeable layer having an inherently open structure.

The first electrolyte-permeable layer and the second electrolyte-permeable layer are preferably configured to be porous. In that case, they may also be referred to as a first porous layer and a second porous layer. Here, porous means that the first electrolyte-permeable layer and the second electrolyte-permeable layer are poriferous and to this extent permeable for the electrolyte.

The first electrolyte-permeable layer and/or the second electrolyte-permeable layer may be formed as a respective fabric.

The foil is preferably configured in such a way that the foil is permeable for the electrolyte only in a direction perpendicular to the foil. The electrolyte thus cannot propagate parallel to the electrically conductive surface through the foil. In particular, the foil thereby differs from the first electrolyte-permeable layer and from the second electrolyte-permeable layer. The foil is thus not porous in the sense of this term as used here. In order to emphasise this, the channels of the foil are also not referred to as pores here. The channels of the foil preferably are respectively unbranched. The channels are preferably separated from one another. The channels thus do not form a network of channels branched or connected with one another.

The arrangement furthermore has an electrode. Preferably, the arrangement furthermore has a voltage source, which is connected on the one hand to the electrically conductive surface and on the other hand to the electrode. With the voltage source, an electrical voltage can be applied between the electrically conductive surface and the electrode in order to grow the nanowires.

The elements of the arrangement are arranged in the following order: the electrically conductive surface, the foil, the first electrolyte-permeable layer and the second electrolyte-permeable layer. The electrode preferably follows on from the second electrolyte-permeable layer in this sequence.

The electrode preferably bears on the second electrolyte-permeable layer. It is, however, also conceivable for example for an intermediate layer, for example in the form of a further electrolyte-permeable layer, to be provided between the electrode and the second electrolyte-permeable layer. The second electrolyte-permeable layer preferably bears on the first electrolyte-permeable layer. It is, however, also conceivable for example for an intermediate layer, for example in the form of a further electrolyte-permeable layer, to be provided between the second electrolyte-permeable layer and the first electrolyte-permeable layer. The first electrolyte-permeable layer preferably bears on the foil. It is, however, also conceivable for example for an intermediate layer, for example in the form of a further electrolyte-permeable layer, to be provided between the first electrolyte-permeable layer and the foil. In all cases, bearing means that there is direct contact between the respective elements.

The foil may bear on the electrically conductive surface. This is not, however, necessary. This applies particularly in the case in which the electrically conductive surface is formed in a recess of a lithography layer. In that case, the foil preferably bears on the lithography layer. Depending on the configuration of the lithography layer and of the electrically conductive surface, it may then be the case that a free space is formed between the electrically conductive surface and the foil. During the growth of the nanowires, this free space is filled with the material of the nanowires. Only subsequently are the channels of the foil filled with the material.

The electrically conductive surface, the foil, the first electrolyte-permeable layer and the second electrolyte-permeable layer preferably form a layer structure. The direction perpendicular to the electrically conductive surface may be referred to as a stack direction. The foil, the first electrolyte-permeable layer and the second electrolyte-permeable layer preferably are respectively formed perpendicularly to the stack direction. This applies in particular for the preferred case in which the foil is configured in the manner of a layer. Preferably, the electrode is also part of the layer structure. Preferably, the electrode is also configured as a layer and, in particular, is also formed perpendicularly to the stack direction.

The arrangement is adapted so that the nanowires can be grown onto the electrically conductive surface by electrodeposition from an electrolyte into the channels of the foil by applying an electrical voltage between the electrically conductive surface and the electrode. The nanowires may be grown by providing an electrolyte. The electrolyte is preferably a liquid, from which the material of the nanowires can be electrodeposited. The electrolyte is arranged during the growth of the nanowires in such a way that both the electrode and the electrically conductive surface are in contact with the electrolyte and are connected to one another by means of the latter. This is possible in particular by the channels of the foil, pores of the first electrolyte-permeable layer and pores of the second electrolyte-permeable layer being filled with the electrolyte. For example, the electrolyte may be introduced into the second electrolyte-permeable layer and be distributed over the channels of the foil by the second electrolyte-permeable layer and the first electrolyte-permeable layer. For example, the arrangement may also have a chamber for the electrolyte. During the growth of the nanowires, the chamber is filled with electrolyte.

With the described arrangement, a substrate may be provided with nanowires over a large area. The described arrangement is, however, also particularly suitable for growing nanowires onto a structured substrate. For example, the surface of a substrate may be structured by lithographic means in such a way that the nanowires are grown only in recesses of a lithography layer. Since lateral growth can be restricted particularly greatly with the described arrangement, regions with nanowires may lie particularly close together without electrical contact occurring between the neighbouring regions with nanowires. For example, electrically conductive pads, which have a small spacing from one another and are electrically insulated from one another, may be grown on with nanowires without lateral growth leading to a short circuit between the electrically conductive pads. Thus, the described arrangement may be used to grow nanowires for the purpose of connecting components with a multiplicity of electrical contacts to one another. By means of the electrically conductive pads grown on with nanowires, a multiplicity of mutually separated electrically conductive connections, which simultaneously connect the components to one another mechanically firmly and/or thermally conductively, may thus be formed between two components.

In one preferred embodiment of the arrangement, the first electrolyte-permeable layer and the second electrolyte-permeable layer are configured to be porous, the second electrolyte-permeable layer having a larger average pore size than the first electrolyte-permeable layer.

In this embodiment, the second electrolyte-permeable layer is more coarsely porous than the first electrolyte-permeable layer. The second electrolyte-permeable layer thus has a comparatively large average pore size. The second electrolyte-permeable layer is therefore highly permeable for the electrolyte, so that the electrolyte can be distributed particularly well. If the second electrolyte-permeable layer were to bear directly on the foil, however, the large pore size would be disadvantageous. When pressing the second electrolyte-permeable layer onto the foil, some of the channels of the foil could be closed by material of the second electrolyte-permeable layer. In order to prevent this, the first electrolyte-permeable layer is provided. Its pores are smaller, so that the likelihood that each of the channels can actually be supplied with electrolyte through one of the pores of the first electrolyte-permeable layer is greater. This is also contributed to by the first electrolyte-permeable layer being less compressible than the second electrolyte-permeable layer. The pores of the first electrolyte-permeable layer therefore still remain open even with a comparatively large pressing force.

The first electrolyte-permeable layer in the uncompressed state preferably has so many pore openings on its surface that on average there are a plurality of pore openings on the surface of the first electrolyte-permeable layer in an area with the size of the cross-sectional area of a channel of the foil. Each channel may therefore be supplied with electrolyte through a plurality of pore openings.

The second electrolyte-permeable layer preferably has a greater average pore size by a factor of from 1 to 20 than the first electrolyte-permeable layer. Preferably, the second electrolyte-permeable layer has a greater number of pores by a factor of from 1 to 20 than the first electrolyte-permeable layer.

The pores of the second electrolyte-permeable layer preferably have an extent in the range of from 30 to 400 nm, particularly in the range of from 100 to 220 nm.

In another preferred embodiment of the arrangement, the second electrolyte-permeable layer in an uncompressed state is more extended than the first electrolyte-permeable layer in a direction perpendicular to the electrically conductive surface.

In the stack direction, the uncompressed second electrolyte-permeable layer thus has a greater extent than the uncompressed first electrolyte-permeable layer. This may also be described as the second electrolyte-permeable layer being thicker than the first electrolyte-permeable layer when both are uncompressed. Preferably, the second electrolyte-permeable layer is more extended by a factor of from 2 to 20 than the first electrolyte-permeable layer in the direction perpendicular to the electrically conductive layer in the uncompressed state.

It has been found that the described division between the first electrolyte-permeable layer and the second electrolyte-permeable layer gives the best results in relation to the uniformity of the growth of the nanowires and the limitation of lateral growth. Because the second electrolyte-permeable layer is relatively large, it can be compressed sufficiently. The less compressible first electrolyte-permeable layer does not need to be larger in order to fulfil its function. This is, in particular, because only a fine distribution of the electrolyte still has to take place in the first electrolyte-permeable layer.

In another preferred embodiment of the arrangement, the first electrolyte-permeable layer is formed with cellulose.

It has been found that cellulose is a particularly suitable material for the first electrolyte-permeable layer. It is therefore preferable for the first electrolyte-permeable layer to be formed exclusively from cellulose. The described advantages are, however, already achieved if the first electrolyte-permeable layer has a proportion of cellulose. Preferably, the first electrolyte-permeable layer is formed to at least 50% from cellulose.

In another preferred embodiment of the arrangement, the second electrolyte-permeable layer is a sponge.

In another preferred embodiment, the arrangement furthermore has a pressing device for generating a force on the second electrolyte-permeable layer in the direction of the electrically conductive surface.

The pressing device preferably comprises a plunger. With the pressing device, the layers of the described layer structure can be compressed. Thus, in particular, the foil can be pressed onto the electrically conductive surface and/or for example onto a lithography layer. Lateral growth may therefore be prevented. If the electrode bears on the second electrolyte-permeable layer, the plunger preferably engages on the electrode. The electrode may be part of the plunger.

As an alternative to a pressing device, the second electrolyte-permeable layer may, for example, also be pressed manually in the direction of the electrically conductive surface.

In another preferred embodiment, the arrangement furthermore has a substrate with a lithography layer, the lithography layer having one or more recesses, and the electrically conductive surface being formed in the one recess or the plurality of recesses.

The lithography layer preferably bears on the substrate. The foil preferably bears on the lithography layer. The electrically conductive surface, onto which the nanowires are grown, is formed in the one recess or the plurality of recesses of the lithography layer. The substrate is preferably a semiconductor substrate, for example consisting of silicon. The substrate may be configured as a wafer. In order to obtain an electrically conductive surface, the substrate may be metallised in the one recess or the plurality of recesses of the lithography layer. The growth of the nanowires may thus be locally limited. If the substrate itself is already electrically conductive, the surface of the substrate in the one recess or the plurality of recesses of the lithography layer itself may be regarded as the electrically conductive surface, onto which the nanowires are grown. The lithography layer preferably has an extent in the range of from 0.1 to 10 μm [micrometres] in a direction perpendicular to the electrically conductive surface.

In particular, in this embodiment a free space may be formed between the electrically conductive surface and the foil. During the growth of the nanowires, this is filled with the material from which the nanowires are subsequently also grown into the channels of the foil.

Preferably, the lithography layer has a multiplicity of recesses. The recesses are preferably arranged regularly. In this case, a pitch preferably lies in the range of from 1 to 10 μm [micrometres]. A pitch is in this case intended to mean the centre spacing of neighbouring recesses.

As a further aspect of the invention, a method for producing a plurality of nanowires with an arrangement configured as described is proposed, wherein the nanowires are grown onto the electrically conductive surface by electrodeposition from an electrolyte into the channels of the foil by applying an electrical voltage between the electrically conductive surface and the electrode.

The described advantages and features of the arrangement may be used and applied for the method, and vice versa. The arrangement is preferably adapted for operation according to the method.

In one preferred embodiment of the method, the second electrolyte-permeable layer is pressed at least temporarily in the direction of the electrically conductive surface.

The invention will be explained in more detail below with the aid of the FIGURE. The FIGURE shows a preferred exemplary embodiment, to which the invention is not restricted. The FIGURE and the size proportions represented therein are only schematic.

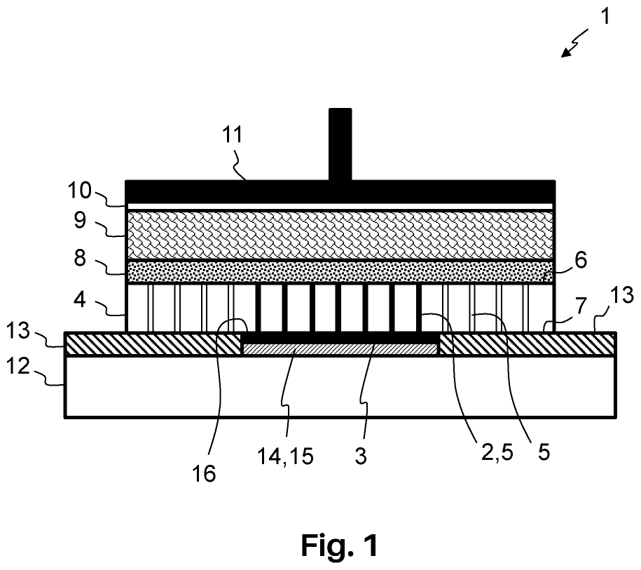

FIG. 1: shows an arrangement according to the invention for producing a plurality of nanowires.

FIG. 1 shows an arrangement 1 for producing a plurality of nanowires 2. The arrangement 1 comprises a substrate 12 with a lithography layer 13. The lithography layer 13 has a recess 14, in which a metallisation layer 15 is formed. By the lithography layer 13, the metallisation layer 15 is limited to the recess 14 and does not extend over the entire substrate 12. The side of the metallisation layer 15 which is the upper side in FIG. 1 forms an electrically conductive surface, which is provided with the reference 3. The nanowires 2 can be grown onto this electrically conductive surface 3. By the lithography layer 13, the growth of the nanowires 2 is limited to the region of the recess 14.

The arrangement 1 furthermore has a foil 4 with a plurality of channels 5. The channels 5 extend from a first side 6 of the foil 4 to a second side 7 of the foil 4 opposite to the first side 6. The foil 4 bears on the lithography layer 13. In the recess 14, the foil 4 may bear on the metallisation layer 15. This, however, is not necessary. In the example of FIG. 1, the foil 4 is therefore shown with a spacing from the metallisation layer 15. For illustration, this spacing is schematically represented as being comparatively large. Although in reality it is in principle possible for the foil 4 and the metallisation layer 15 to bear on one another, it does not do so very tightly so that electrodeposition of material between the foil 4 and the electrically conductive surface 3 can actually take place locally during the growth of the nanowires 2 between the foil 4 and the metallisation layer 15.

The arrangement 1 furthermore comprises a first electrolyte-permeable layer 8, which bears on the foil 4, and a second electrolyte-permeable layer 9 which bears on the first electrolyte-permeable layer 8. The first electrolyte-permeable layer 8 and the second electrolyte-permeable layer 9 are configured to be porous. The second electrolyte-permeable layer 9 is more compressible than the first electrolyte-permeable layer 8, has a larger average pore size than the first electrolyte-permeable layer 8 and is more extended than the first electrolyte-permeable layer 8 in a direction perpendicular to the electrically conductive surface. The first electrolyte-permeable layer 8 is formed from cellulose. The second electrolyte-permeable layer 9 is a sponge.

The arrangement 1 furthermore has an electrode 10, which bears on the second electrolyte-permeable layer 9. The arrangement 1 additionally has a plunger as a pressing device 11 for generating a force on the second electrolyte-permeable layer 9 in the direction of the electrically conductive surface 3. In the embodiment shown, the pressing device 11 bears on the electrode 10 and can exert a force through the latter onto the second electrolyte-permeable layer 9 in the direction of the electrically conductive surface 3. By this force, the foil 4, the first electrolyte-permeable layer 8 and the second electrolyte-permeable layer 9 are compressed between the lithography layer 13, or the electrically conductive surface 3, and the electrode 10.

The arrangement 1 is adapted so that the nanowires 2 can be grown onto the electrically conductive surface 3 by electrodeposition from an electrolyte into the channels 5 of the foil 4 by applying an electrical voltage between the electrically conductive surface 3 and the electrode 10. This is possible by the electrode 10 and the electrically conductive surface 3 being brought in contact with the electrolyte so that the electrode 10 and the electrically conductive surface 3 are connected to one another by means of the electrolyte. In particular, for this purpose the channels 5 of the foil 4, pores of the first electrolyte-permeable layer 8 and pores of the second electrolyte-permeable layer 9 may be filled with the electrolyte. In the region of the recess 14, electrodeposition of material then takes place from the electrolyte onto the electrically conductive surface 3. Insofar as there is a spacing between the electrically conductive surface 3 and the foil 4, as shown, a filling 16 is initially formed. Subsequently, the channels 5 of the foil 4 are filled with deposited material. This material constitutes the nanowires 2.

After the growth of the nanowires 2, the pressing device 11, the electrode 10, the second electrolyte-permeable layer 9 and the first electrolyte-permeable layer 8 may be removed. The foil 4 may, for example, be dissolved by etching in order to expose the nanowires 2. The lithography layer 13 may likewise be removed chemically. As a result, the nanowires 2 remain on an electrically conductive pad on the substrate 12. The electrically conductive pad is formed by the metallisation layer 15 and the filling 16.

The project which led to this application received funding from the research and innovation programme “Horizon 2020” of the European Union under grant contract number 830061.

### LIST OF REFERENCES

1 arrangement
2 nanowires
3 electrically conductive surface
4 foil
5 channels
6 first side of the foil
7 second side of the foil
8 first electrolyte-permeable layer
9 second electrolyte-permeable layer
10 electrode
11 pressing device
12 substrate
13 lithography layer
14 recess
15 metallisation layer
16 filling

1. Arrangement for producing a plurality of nanowires, comprising the following elements, which are arranged in the order indicated:
an electrically conductive surface,
a foil having a plurality of channels, which extend from a first side of the foil to a second side of the foil opposite to the first side,
a first electrolyte-permeable layer,
a second electrolyte-permeable layer, which is more compressible than the first electrolyte-permeable layer,
wherein the arrangement furthermore has an electrode, and wherein the arrangement is adapted so that the nanowires can be grown onto the electrically conductive surface by electrodeposition from an electrolyte into the channels of the foil by applying an electrical voltage between the electrically conductive surface and the electrode.

2. Arrangement according to claim 1, wherein the first electrolyte-permeable layer and the second electrolyte-permeable layer are configured to be porous, and wherein the second electrolyte-permeable layer has a larger average pore size than the first electrolyte-permeable layer.

3. Arrangement according to claim 1, wherein in an uncompressed state the second electrolyte-permeable layer is more extended than the first electrolyte-permeable layer in a direction perpendicular to the electrically conductive surface.

4. Arrangement according to claim 1, wherein the first electrolyte-permeable layer is formed with cellulose.

5. Arrangement according to claim 1, wherein the second electrolyte-permeable layer is a sponge.

6. Arrangement according to claim 1, furthermore having a pressing device for generating a force on the second electrolyte-permeable layer in the direction of the electrically conductive surface.

7. Arrangement according to claim 1, furthermore having a substrate with a lithography layer, wherein the lithography layer has one or more recesses, and wherein the electrically conductive surface is formed in the one recess or the plurality of recesses.

8. A method for producing a plurality of nanowires with an arrangement according to claim 1, wherein the nanowires are grown onto the electrically conductive surface by electrodeposition from an electrolyte into the channels of the foil by applying an electrical voltage between the electrically conductive surface and the electrode.

9. The method as claimed in claim 8, wherein the second electrolyte-permeable layer is pressed at least temporarily in the direction of the electrically conductive surface.

10. Arrangement according to claim 2, wherein in an uncompressed state the second electrolyte-permeable layer is more extended than the first electrolyte-permeable layer in a direction perpendicular to the electrically conductive surface.

11. Arrangement according to claim 2, wherein the first electrolyte-permeable layer is formed with cellulose.

12. Arrangement according to claim 3, wherein the first electrolyte-permeable layer is formed with cellulose.

13. Arrangement according to claim 2, wherein the second electrolyte-permeable layer is a sponge.

14. Arrangement according to claim 3, wherein the second electrolyte-permeable layer is a sponge.

15. Arrangement according to claim 4, wherein the second electrolyte-permeable layer is a sponge.

16. Arrangement according to claim 2, furthermore having a pressing device for generating a force on the second electrolyte-permeable layer in the direction of the electrically conductive surface.

17. Arrangement according to claim 3, furthermore having a pressing device for generating a force on the second electrolyte-permeable layer in the direction of the electrically conductive surface.

18. Arrangement according to claim 4, furthermore having a pressing device for generating a force on the second electrolyte-permeable layer in the direction of the electrically conductive surface.

19. Arrangement according to claim 5, furthermore having a pressing device for generating a force on the second electrolyte-permeable layer in the direction of the electrically conductive surface.

20. Arrangement according to claim 2, furthermore having a substrate with a lithography layer, wherein the lithography layer has one or more recesses, and wherein the electrically conductive surface is formed in the one recess or the plurality of recesses.
